(19) United States
(12) Patent Application Publication
(10) Pub. No.: US 2024/0068503 A1
(43) Pub. Date: Feb. 29, 2024

(54) CLAMP DEVICE

(71) Applicant: GANTRY RAILING LTD., Gloucester, Gloucestershire (GB)

(72) Inventors: Reece George HALLING, Gloucester, Gloucestershire (GB); Alexander Daniel Barrons NELSON, Gloucester, Gloucestershire (GB); Peter Nathan BYGRAVE, Gloucester, Gloucestershire (GB)

(73) Assignee: GANTRY RAILING LTD., Gloucester, Gloucestershire (GB)

(21) Appl. No.: 18/259,959

(22) PCT Filed: Dec. 30, 2020
(86) PCT No.: PCT/GB2020/053378

§ 371 Date: Jun. 29, 2023

(30) Foreign Application Priority Data
Jan. 22, 2020 (GB) 2000947.8

(51) Int. Cl. F16B 39/08; F16B 37/14

(52) U.S. Cl. CPC F16B 39/08; F16B 37/14

(57) ABSTRACT

A clamp device for clamping a boom hinge rail 12 of gantry crane in-situ comprises a cap portion 14 slidably mounted on a base portion 13 and secured together by a Locking bolt 15, the cap portion 14 comprising a body 18 and a nose 19 which extends laterally outwardly from the body 18 along a nose axis. The clamp portion 13 and the body 18 of the cap portion 14 comprise complementary opposed arcuate mating surfaces 21, 22 which permit rotational movement to the cap portion 14 relative to the base portion 13 about an axis P which extends perpendicular to the 10 nose axis. The base and cap portions 13, 14 of the clamp always engage each other regardless of the position of the nose of the clamp, so that forces applied to the nose 19 of the clamp 10 by the rail 12 are directly applied to the base portion 13 of the clamp 10, thereby providing a clamp which is less prone to failure.

This invention relates to a clamp device more particularly but not solely to a clamp device for clamping a rail or track to a support surface on a gantry crane.

Gantry cranes are widely used in dockyards and other areas for handling articles. Typically, gantry cranes comprise a large wheeled chassis for running on the ground along a first axis and an elevated boom extending along a second axis, which extends perpendicular to the first axis. Articles being handled by the crane are supported by a cable which depends from a trolley that is mounted for movement along the longitudinal axis of the boom. Typically, the trolley has wheels which run on rails fixed to a support surface on the boom by a plurality of clamps disposed along the length of the rail on opposite sides thereof.

Cranes for handling containers in dockyards may comprise hinged booms, which extend from the chassis across the width of a docked ship. The hinged boom can be raised or lowered to allow ships to enter and leave the dock unhindered.

The rails of hinged boom gantry cranes can be subjected to very high duty cycles of vibration and shock due to the continual trolley movements and discontinuity between the adjacent ends of the static and moveable portions of the rails and to uneven rail support surfaces. Known clamps for hinged boom rails attempt to minimise the effects of the foregoing by keeping the rails static, so as to create a smooth transition between the rail portions as the boom hinge operates. Known clamps generally comprise a cap portion for engaging the rail, a base portion, an interconnecting bolt and a nut which can be tightened against a washer on the bolt to clamp the cap portion against the rail.

One such known clamp does not comprise a cap nose portion that can be adjusted vertically to suit a range of rail flange positions. This type of clamp has many disadvantages as it cannot accommodate the variations in the flatness of the rail supporting beam and the production tolerances of the rails. Some of these clamps are machined to a high degree of accuracy which costs a lot of money and even then, they seldom fit properly. At the other end of the scale, there are poor quality fabricated clamps with welded metal noses and the cap portion deforms under tightening but again this induces a lot of stresses which are locked into the clamp and can ultimately cause it to fail.

Another known type of clamp has a cap that can rock or pivot about a rear pivot. In use, the nut and washer induce bending and stress concentrations in the bolt. This so-called prying action combined with the high cycles applied to an already unevenly stressed bolt can cause the bolt to fail.

With the foregoing in mind, we have now improved an improved clamp device.

In accordance with the present invention, there is provided a clamp device comprising a cap portion slidably mounted on a base portion and secured together by a locking bolt, wherein the cap portion comprises a body and a nose which extends laterally outwardly from the body along a nose axis, the body of the cap portion and the base portion comprising complementary opposed arcuate mating surfaces, which permit rotational movement to the cap portion relative to the base portion about an axis which extends perpendicular to the nose axis.

In use, the base portion is fixed to a support surface on the boom alongside the rail, for example by welding, such that the rotational axis of the clamp extends parallel to the longitudinal axis of the rail and such that the nose of the cap portion of the clamp overhangs a lateral flange which extends longitudinally of the rail. The nose of the clamp can then be rotated against the flange of the rail to urge the latter against the support surface, whereupon the bolt can be tightened to hold the rail in-situ. It will be appreciated that the provision of the arcuate mating surfaces between the cap and base portions of the clamp provide an arrangement whereby the cap and base portions of the clamp always engage each other regardless of the position of the nose of the clamp. The bolt may also be arranged to pivot about an axis which extends perpendicular to the nose axis. In this manner, the bolt is solely subjected to evenly distributed tensile forces arising from tightening of the bolt and from vertical forces applied to the cap portion by the lateral flange of the rail. Any lateral forces from the rail are also resisted by the bolt in tension, as these forces are converted to a vertical force on the cap and bolt due to the wedge-shaped profile of the lateral flange. Accordingly, it is the even distribution of these forces that make the bolt of the present invention less prone to failure.

The clamp may be arranged such that tightening of the bolt causes rotational movement of the cap portion of the clamp relative to the base portion in a clamping direction. The rotational axis of the cap portion relative to the base portion may disposed on an opposite side of the clamp to the nose, the bolt acting to constrain the cap portion against base portion along an axis which extends along a chord of a circle defined by the arcuate mating surfaces. In this manner, tightening of the bolt applies both a compressive and rotational force between the cap and base portions of the clamp, which causes the nose of the clip to move in a clamping direction against the rail as the bolt is tightened.

The bolt may comprise a head and a shaft upstanding from the head for engaging a nut that seats against a flat on the cap portion of the clamp, the head being rotatably mounted to the base portion of the clamp for pivotable movement about an axis which extends parallel to the rotational axis of the clamp and perpendicular to the axis of the shaft of the bolt. In this manner, the shaft of the bolt swings as the cap portion is rotated, thereby ensuring that the shaft of the bolt extends perpendicular to the plane of the flat regardless of the rotational position of the cap portion of the clamp. This ensures that the nut remains fully seated on the flat and prevents localised stress concentrations in the bolt.

The head of the bolt may comprise an arcuate surface from which the shaft extends, the arcuate surface of the bolt bearing against a complementary arcuate surface on the base portion of clamp.

The clamp may comprise a plurality of bolts.

An embodiment of the present invention will now be described by way of an example only and with reference to the accompanying drawings, in which:

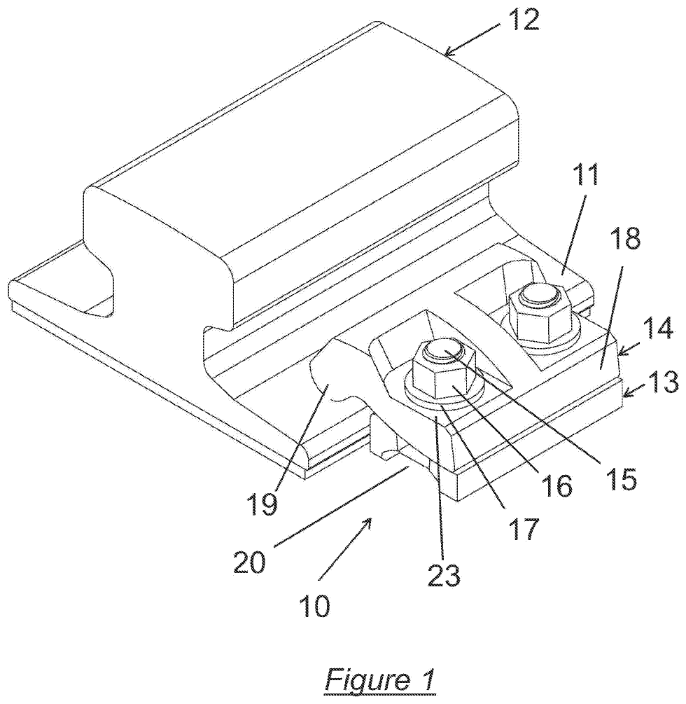

FIG. 1 is a perspective view from one side and above of a section of boom hinge rail fixed to a support surface by a clamp device in accordance with the present invention; and

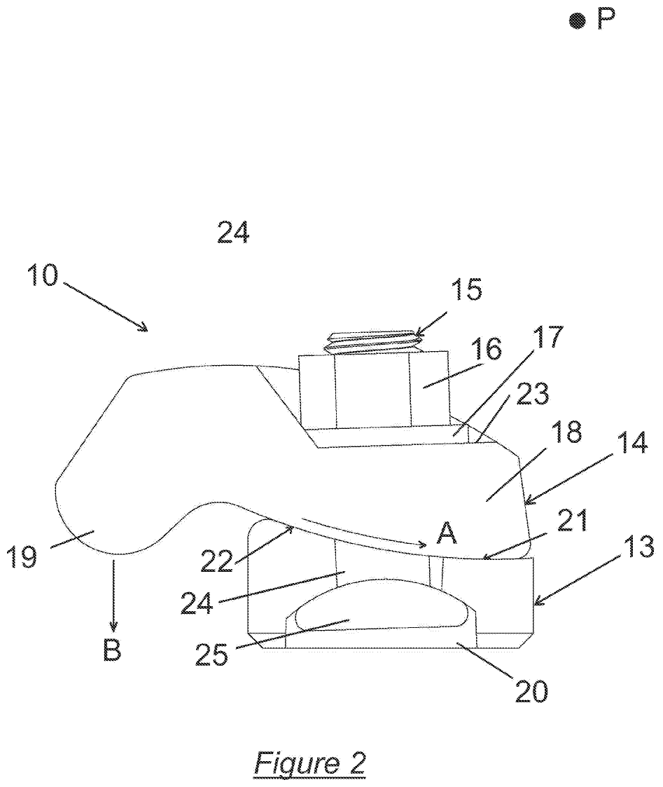

FIG. 2 is a sectional view through the clamp device of FIG. 1.

Referring to the drawings, there is shown a clamp device 10 disposed in clamping engagement with a lateral side flange 11 of an elongate boom hinge rail 12. It will be appreciated that a plurality of such clamps 10 will be provided along both sides of the rail 12 at suitably-spaced intervals.

The clamp device 10 comprises a base portion 13 which is fixed is to a support surface on the boom of the crane alongside the rail 12, for example by welding. The base portion 13 comprises an elongate convex arcuate upper surface 22, which extend up longitudinally of the rail 12. The arc of the surface 22 is centred about a rotational axis P which extends longitudinally above the rail 12 at a point disposed outwardly of the clamp 10.

The clamp 10 further comprises a cap portion 14 having a body 18 which is slidably seated on the base portion 13 for movement in direction towards or away from the rail 12. The underside of the body 18 of the cap portion 14 comprises an elongate convex arcuate surface 22 seated against the concave arcuate surface 21 of the base portion 13 of the clamp 10. The cap portion of the clamp 10 further comprises a nose 19 which extends laterally from the body 14 to a point disposed outwardly of the base portion 13 of the clamp 10.

The cap portion 14 is clamped to the base portion 13 of the clamp 10 by a pair of bolts 15. The bolts 15 each comprise a head 25 which is mounted in a slot 20 formed in a respective end face of the base portion 13 of the clamp 10. The bolts 15 further comprise an elongate threaded shaft 24 which extends upwardly through aligned apertures in the base and cap portions 13, 14 of the clamp 10. The head 25 of the bolts 15 comprise an arcuate abutment surface which engage respective complementary surfaces on the roof of respective slots 20, so that the head 25 of each bolt 15 can pivot about an axis which extends parallel to the rotational axis P of the cap portion 14 of the clamp 10 and perpendicular to the shaft 24 of the bolt 15. Each bolt 15 has a nut 16 threadably engaged with the upper end of its shaft 24 which constrains a washer 17 against a respective flat 23 formed on the upper surface of the cap portion 14.

In use, the bolt 15 is tightened by rotating the nut 16 to cause the washer 17 to bear against the flat surface 23 on the cap portion 14 of the clamp 10. Since the axis of the shaft 24 of the bolt 15 does not extend directly radially of the mating arcuate surfaces 21, 22 of the base and cap portions 13, 14 of the clamp 10, tightening of the bolt 15 applies both a compressive and rotational force to the cap portion 14, causing the cap portion 14 to rotate in direction A, thereby causing the nose 19 of the cap portion 14 to move downwardly in a tightening direction B against the flange 11 of the rail 12.

It will be appreciated that the base and cap portions 13, 14 of the clamp are always in engagement with each other regardless of the height of the nose 19 of the clamp. In this manner, a single type of clamp is able to securely clamp the rail 12 in-situ over a wide range of clamping distances that may be caused by rail discontinuities or uneven support surfaces.

1. A clamp device comprising a cap portion slidably mounted on a base portion and secured together by a locking bolt, wherein the cap portion comprises a body and a nose which extends laterally outwardly from the body along a nose axis, the body of the cap portion comprising a convex arcuate surface on the underside thereof which is seated on a complementary opposed concave arcuate mating surface of the base portion, the surfaces, permitting rotational movement of the cap portion relative to the base portion about an axis which extends perpendicular to the nose axis.

2. A clamp device as claimed in claim 1, arranged such that tightening of the bolt causes rotational movement of the cap portion of the clamp relative to the base portion in a clamping direction.

3. A clamp device as claimed in claim 2, in which the rotational axis of the cap portion relative to the base portion is disposed on an opposite side of the clamp to the nose, the bolt acting to constrain the cap portion against base portion along an axis which extends along a chord of a circle defined by the arcuate mating surfaces.

4. A clamp device as claimed in claim 1, in which the bolt is arranged to pivot about an axis which extends perpendicular to the nose axis.

5. A clamp device as claimed in claim 4, in which the bolt comprises a head and a shaft upstanding from the head for engaging a nut that seats against a flat on the cap portion of the clamp, the head being rotatably mounted to the base portion of the clamp for pivotable movement about an axis which extends parallel to the rotational axis of the clamp and perpendicular to the axis of the shaft of the bolt.

6. A clamp device as claimed in claim 5, in which the head of the bolt comprises an arcuate surface from which the shaft extends, the arcuate surface of the bolt bearing against a complementary arcuate surface on the base portion of clamp.

7. A clamp device as claimed in claim 1, in which the clamp comprises a plurality of bolts.
